(19) United States
(12) Patent Application Publication
(10) Pub. No.: US 2006/0256754 A1
(43) Pub. Date: Nov. 16, 2006

(54) Multi-band and multi-mode mobile terminal for wireless communication systems

(76) Inventors: Ji Gang Liu, Shanghai (CN); Xuecheng Qian, Shanghai (CN)

Correspondence Address: PHILIPS INTELLECTUAL PROPERTY & STANDARDS, P.O. BOX 3001, BRIARCLIFF MANOR, NY, 10510, US

(21) Appl. No.: 10/557,381

(22) PCT Filed: Apr. 16, 2004
(86) PCT No.: PCT/IB04/50466

§ 371 Date: Nov. 18, 2005

(30) Foreign Application Priority Data
May 23, 2003 (CN) 03136678.3

(51) Int. Cl. H04B 7/216; H04J 3/16

(52) U.S. Cl. 370/335; 370/466

(57) ABSTRACT

A mobile terminal in wireless communication systems, comprising a control unit, for generating control information according to the bands and modes corresponding to signals to be received and signals to be transmitted; a band switching unit, for switching to the propagation path of the corresponding band to transfer corresponding signals, according to the control information; a mode switching unit, for switching to the propagation path of the corresponding mode to transmit signals in the propagation paths of the corresponding band and the corresponding mode, according to the control information; an RF processing unit, for RF processing the signals transferred from the propagation path of the corresponding mode in corresponding band, RF processing the signals to be transferred in corresponding band and then transferring them to the propagation path of the corresponding mode; a base-band processing unit, for converting RF signals from the RF processing unit into base-band signals, and transferring the base-band signals to be transferred to the RF processing unit. The mobile terminal can flexibly select working mode and band in multi-mode, multi-band communication systems.

### FIELD OF THE INVENTION

The present invention relates generally to a mobile terminal for use in wireless communication systems, and more particularly, to a mobile terminal capable of working in multi-band and multi-mode for use in wireless communication systems.

### BACKGROUND OF THE ART

The 2G mobile communication networks, still in operation so far, such as GSM and CDMA (IS95), work at 900 MHz or 1800 MHz, wherein GSM works in TDD mode while CDMA (IS95) in FDD mode. With requirement for system performance and capacity going higher and higher, existing 2G mobile communication systems are gradually evolving towards 3G mobile communication systems.

3G communication systems work at around 2000 MHz and can be classified into three mainstreams: WCDMA, CDMA2000 and TD-SCDMA, wherein WCDMA and CDMA2000 work in FDD mode while TD-SCDMA in TDD mode. Nowadays, TD-SCDMA has been accepted by 3GPP as a low-chip-rate TDD option and is parallel to the high-chip-rate option of WCDMA in overall performance.

Old network systems have been established for a long period and thus may offer better coverage than the new ones, so the new and old network systems would coexist for a long time, therefore it's necessary for a new mobile terminal to work well in coverage areas of new networks as well as in those of old networks. But each communication system has different air interface protocols, working mode and operating frequency, so existing mobile terminals can't satisfy this requirement without modifications.

A dual-mode mobile terminal has already come in market, but it neglects TD-SCDMA who joined 3G standard in 2001, especially the problem of working in different frequencies and modes. So, it is of great necessity to offer a mobile terminal capable of working in both 2G and 3G mobile communication systems.

### SUMMARY OF THE INVENTION

An object of the present invention is to provide a multi-mode and multi-band mobile terminal for use in wireless communication systems, wherein the mobile terminal can perform communication with various communication systems, especially with GSM, CDMA (IS95), TDD-based TD-SCDMA and FDD-based WCDMA systems, through integrating components capable of communicating with both 2G and 3G networks.

Another object of the present invention is to provide a multi-mode and multi-band mobile terminal for use in wireless communication systems, wherein the mobile terminal can save manufacturing cost and improve integrity through sharing some components in different modes and different frequencies, and realizes more flexible selections of multi-band and multi-mode by utilizing switching unit, duplex unit and control unit.

A mobile terminal proposed for use in wireless communication systems is according to the present invention, comprising: a control unit, for generating control information according to the band corresponding to the received signals and signals to be transmitted; a band switching unit, for switching to the propagation path of the corresponding bands, so as to transfer corresponding signals, according to the control information; an RF processing unit, for RF processing received signals transferred via the propagation path of the corresponding band, and RF processing the signals to be transmitted, then transmitting the processed signals via the band switching unit, according to the control information; a baseband processing unit, for converting RF signals from the RF processing unit into baseband signals, and transferring the baseband signals to be transmitted to the RF processing unit for RF processing, according to the control information.

A mobile terminal proposed for use in wireless communication systems according to the present invention, comprising: a control unit, for generating control information according to the band corresponding to the received signals and signals to be transmitted; a band switching unit, for switching to the propagation path of the corresponding bands to transfer the corresponding signals, according to the control information; an RF processing unit, for RF processing the signals transferred from the band switching unit, and RF processing signals to be transmitted in corresponding bands according to the control information so as to transmit the RF signals from the band switching unit; a baseband processing unit, for converting the RF signals from the RF processing unit into baseband signals, and transferring the baseband signals to be transmitted to the RF processing unit for RF processing according to the control information.

A mobile terminal proposed for use in wireless communication systems according to the present invention, comprising: a control unit, for generating control information according to the mode corresponding to the received signals and signals to be transmitted; a mode switching unit, for switching to the propagation path of the corresponding mode to transmit the corresponding signals, according to the control information; an RF processing unit, for RF processing the received signals transferred from the propagation path of the corresponding mode, RF processing the RF signals to be transmitted and then transmitting the RF signals from the propagation path of the corresponding mode; a baseband processing unit, for converting RF signals from said RF processing unit into baseband signals, and transferring the baseband signals to be transmitted to the RF processing unit to be RF processed.

A communication method proposed to be executed by a UE in wireless communication systems according to the present invention, comprising: determining the band corresponding to the received signals, according to the received radio signals; RF processing the received signals in corresponding band, according to the determined band; baseband processing the RF processed signals.

According to the embodiment in the present invention, the method further includes: determining the band corresponding to signals to be transmitted; RF processing the baseband processed signals in corresponding band, according to the determined band; transmitting the RF signals corresponding to said band.

According to the embodiment in the present invention, the method further includes: determining the mode corresponding to the received signals and signals to be transmitted; transferring the received signals and signals to be transmitted, according to determined mode.

### BRIEF DESCRIPTION OF THE DRAWINGS

FIG. 1 illustrates an embodiment in which the mobile terminal proposed in the present invention receives and transmits signals.

### DETAILED DESCRIPTION OF THE INVENTION

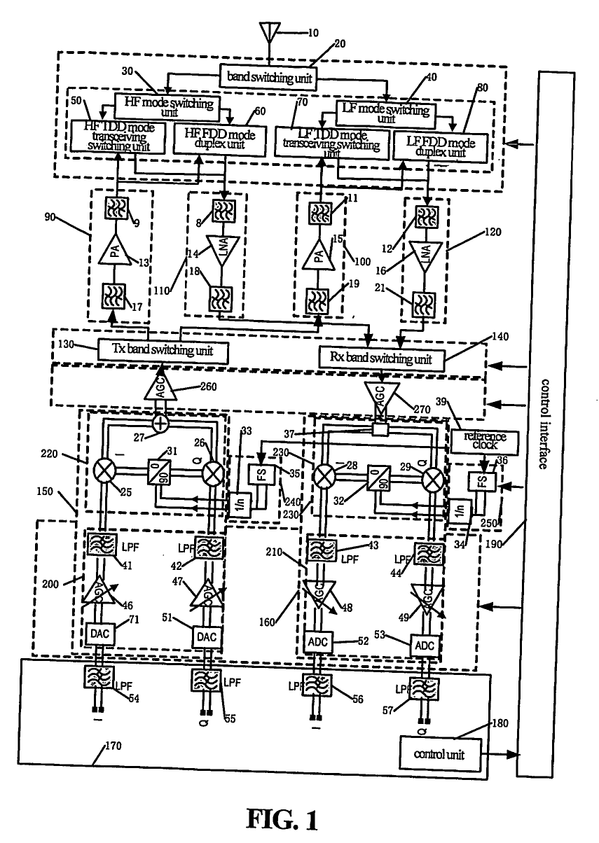

FIG. 1 illustrates an embodiment for the mobile terminal proposed in the present invention.

As shown in FIG. 1, at receiving signals, the RF signals received via antenna 10 are transferred to band switching unit 20 consisting of a HPF (High-Pass Filter) and a LPF (Low-Pass Filter). When the indication from control unit 180 indicates that the received signals are HF (High Frequency) signals (e.g. frequency of the received signals is higher than 1500 MHz), the received signals are transferred to HF mode switching unit 30 via band switching unit 20; when the indication from control unit 180 indicates that the received signals are LF (Low Frequency) signals (e.g. frequency of the received signals is lower than 1000 MH), the received signals are transferred to LF band switching unit 40 via band switching unit 20.

Afterwards, the received signals are transferred to the corresponding mode selection switching units, according to the control instruction from control unit 180, that is: if the input signals are HF signals, the received signals are transferred to HF TDD mode transceiving switching unit 50 when the control instruction indicates the working mode for receiving signals currently is TDD, and to HF FDD mode duplex unit 60 when FDD; if the input signals are LF signals, the received signals are transferred to LF TDD mode transceiving switching unit 70 when the control instruction indicates the working mode for receiving signals currently is TDD and to LF FDD mode duplex unit 80 when FDD.

If the received signals are inputted through HF TDD mode transceiving switching unit 50 or HF FDD mode duplex unit 60, the received signals are inputted into HF Rx RF processing unit 110 consisting of RF filter 8, LNA (Low Noise Amplifier) 14 and BPF 18, and the input signals processed by HF Rx RF processing unit 110 are transferred to Rx band switching unit 140 after being filtered by RF filter 8 and BPF 18 and amplified by LNA 14. If the received signals are inputted through LF TDD mode transceiving switching unit 70 or LF FDD mode duplex unit 80, the received signals are inputted into LF Rx RF processing unit 120 consisting of RF filter 12, LNA 16 and BPF 21, and the input signals processed by LF Rx RF processing unit 120 are transferred to Rx band switching unit 140 after being filtered by RF filter 12 and BPF 21 and amplified by LNA 16.

With indication of the control instruction from control unit 180, the signals processed by HF Rx RF processing unit 110 or LF Rx RF processing unit 120, are transferred to AGC (Automatic Gain Control) 270 via Rx band switching unit 140.

With indication of the control instruction from control unit 180, the signal amplified by AGC 270 are inputted into Rx processing unit 160 composed of demodulating unit 230, Rx LO (Local Oscillation) generating unit 250 and Rx baseband unit 210. Rx processing unit 160 can be shared by received signals in different modes and in different frequencies. In Rx processing unit 160, the input signals amplified by AGC 270 are transferred to demodulating unit 230 composed of mixers 28 and 29, divider 37 and phase shifter 32, for demodulation. Wherein the LO used by the demodulating unit 230 is supplied by Rx LO generating unit 250. In Rx LO generating unit 250, the frequency signals outputted by FS (Frequency Synthesizer) 36 based on reference clock 39, provide LO signals corresponding to the received signals to phase shifter 32 after being divided by divider 34 controlled by control unit 180. The demodulated signals, i.e. the I&Q signals, are inputt ed into digital processing unit 170 via analog LPFs 43 and 44, AGCs 48 and 49, ADCs 52 and 53 in Rx baseband unit 210.

In digital processing unit 170, the baseband digital in-phase signals and quadrature-phase signals acquired through Rx processing unit 160, are processed further after filtered by digital filters 56 and 57.

A description is given above to the collaboration relationship between each component of the mobile terminal provided in the present invention at receiving signals, in conjunction with FIG. 1. In the following, an explanation will go to the collaboration relationship between each component of the mobile terminal at transmitting signals, in conjunction with FIG. 1.

As best shown in FIG. 1, at transmitting signals, control unit 180 first determines the working mode and frequency band for transmitting the signals, that is, to communicate in TDD or FDD mode, adopting 2G LF carrier signals or 3G HF carrier signals.

Afterwards, the baseband digital in-phase signals and quadrature-phase signals to be transmitted, i.e. I&Q signals, are transferred to Tx processing unit 150 composed of Tx baseband unit 200, modulating unit 220 and Tx LO generating unit 240 after being filtered by digital filters 54 and 55 in digital processing unit 170.

Tx processing unit 150 can be shared by transmitting signals in different modes and different frequencies. In Tx processing unit 150, the baseband digital I&Q signals are respectively processed in turn through DACs 71 and 51, AGCs 46 and 47, baseband filters 41 and 42 in Tx baseband unit 200, to generate baseband analog I&Q signals. Then, the baseband analog I&Q signals are inputted into modulating unit 220 consisting of mixers 25 and 26, combiner 27 and phase shifter 31, for modulation. Wherein the LO used by modulating unit 220 is provided by Tx LO generating unit 240 and in Tx LO generating unit 240, FS 35 outputs frequency signals based on reference clock 39 and outputs HF or LF LO signals to phase shifter 31 after being divided by divider 33 controlled by control u nit 180. The signals modulated by modulating unit 220, are transferred to AGC 260.

With indication of the control instruction from control unit 180, the signals amplified by AGC 260 are transferred to Tx band switching unit 130. Depending on the band of the demodulated signals, the signals to be transmitted are transferred to HF Tx RF processing unit 90 or LF Tx RF processing unit 100 via Tx band switching unit 130. If the modulated signals to be transmitted are HF signals, after respectively being filtered in turn by Tx BPF 17 and RF BPF 9 and amplified by power amplifier 13 in HF Tx RF processing unit 90, the signals to be transmitted are transferred to HF TDD mode transceiving switching unit 50 or HF FDD mode duplex unit 60. That is: when in TDD mode, under the control of control unit 180, the signals to be transmitted are transferred to HF TDD mode transceiving switching unit 50; when in FDD mode, under the control of control unit 180, the signals to be transmitted are transferred to HF FDD mode duplex u nit 60. The signals transferred through HF TDD mode transceiving switching unit 50 or HF FDD mode duplex unit 60, are transmitted by antenna unit 10 via band switching unit 20 after passing through HF mode switching unit 30.

If the modulated signals to be transmitted are LF signals, after respectively being filtered in turn by Tx BPF 19 and RF BPF 11 and amplified by power amplifier 15 in LF Tx RF processing unit 100, the signals to be transmitted are transferred to LF TDD mode transceiving switching unit 70 or LF FDD mode duplex unit 80. That is: when in TDD mode, under the control of control unit 180, the signals to be transmitted are transferred to LF TDD mode transceiving switching unit 70; when in FDD mode, under the control of control unit 180, the signals to be transmitted are transferred to LF FDD mode duplex unit 80. The signals transferred through LF TDD mode transceiving switching unit 70 or LF FDD mode duplex unit 80, are transmitted by antenna unit 10 via band switching unit 20 after passing through LF mode switching unit 40.

In the embodiment of the present invention, control unit 180 can be an independent module, or a component in digital processing unit 170. During the communication process of transmitting and receiving signals, control unit 180 controls the operation of other units through control interface 190.

In the embodiment of the present invention, HF TDD mode transceiving switching unit and LF TDD mode transceiving switching unit, are switched to corresponding Rx path and Tx path at different time during process of receiving and transmitting radio signals, HF FDD mode duplex unit and LF FDD mode duplex unit, transfer the received radio signals and the signals to be transmitted to corresponding Rx path and Tx path during process of receiving and transmitting radio signals.

Furthermore, in the embodiment of the present invention, FSs 35 and 36 can generate signals at frequency of about 4 GHz, dividers 33 and 34 can obtain orthogonal carrier signals at frequency of about 2 GHz if the 4 GHz signals are divided by 2, and obtain orthogonal carrier signals at frequency of about 900 MHz if the 4 GHz signals are divided by 4. In this way, the problem of carrier leakage can be settled effectively, and thus provide ideal carrier signals.

### BENEFICIAL RESULTS OF THE INVENTION

Descriptions are given above to the operation of receiving and transmitting signals for the mobile terminal provided by the present invention, in conjunction with FIG. 1, wherein near the antenna's front end, switching to the signal propagation path corresponding to different working mode, can be achieved through controlling the mode switching unit composed of HF mode switching unit 30, LF mode switching unit 40, HF TDD mode transceiving switching unit 50, LF TDD mode transceiving switching unit 70, HF FDD mode duplex unit 60 and LF FDD mode duplex unit 80. So, the mobile terminal in the present invention can select its working mode flexibly in a multi-mode communication system. Moreover, the mobile terminal in the present invention can receive radio signals in different frequency bands, through band switching unit 20 and the Rx signal processing module in the RF processing unit composed of HF Rx RF processing unit 110, LF Rx RF processing unit 120, Rx band switching unit 140, demodulating unit 230 and Rx LO generating unit 250. The mobile terminal in the present invention can transmit radio signals in different frequency bands, through band switching unit 20 and the Tx signal processing module in the RF processing unit composed of HF Tx RF processing unit 90, LF Tx RF processing unit 100, Tx band switching unit 130, modulating unit 220 and Tx LO generating unit 240.

Furthermore, in the mobile terminal described in the present invention, the baseband processing unit can be shared by radio signals in different bands and different working modes, and the RF processing unit can be shared by radio signals in different modes, so the mobile terminal provided in this invention can greatly save manufacturing cost and improve integrity.

1. A mobile terminal in wireless communication systems, comprising:
a control unit, for generating control information according to the bands corresponding to signals to be received and signals to be transmitted;
a band switching unit, for switching to the propagation path of the corresponding band, so as to transfer corresponding signals, according to the control information;
an RF processing unit, for RF processing received signals transferred via the propagation path of the corresponding band, and RF processing the signals to be transmitted, then transmitting the processed signals via the band switching unit, according to the control information;
a base-band processing unit, for converting RF signals from the RF processing unit into base-band signals, and transferring the base-band signals to be transmitted to the RF processing unit to complete the RF processing, according to the control information.

2. The mobile terminal according to claim 1, wherein said RF processing unit comprises:
a Tx (transmitting) signal processing module, for RF processing signals to be transmitted from said base-band processing unit, so as to transmit the RF signals via said band switching unit;
a plurality of Rx (receiving) RF processing units corresponding to different bands, for RF processing received signals transferred via the propagation paths of said corresponding bands;
an Rx (receiving) band switching unit, for receiving RF signals from the Rx RF processing units of said corresponding bands, according to said control information;
a demodulating module, for demodulating RF signals from the Rx band switching unit, and outputting the demodulated signals to said base-band processing unit, according to said control information.

3. The mobile terminal according to claim 2, wherein said Tx signal processing module comprises:
a modulating module, for modulating signals to be transmitted from said base-band processing unit into RF signals, according to said control information;
a Tx (transmitting) band switching unit, for switching the modulated signals to the transmission path of corresponding band, according to said control information;
a plurality of Tx (transmitting) RF processing units corresponding to different bands, for RF processing the modulated signals from the Tx band switching unit in corresponding bands, so as to transmit the RF signals from said band switching unit.

4. A mobile terminal in wireless communication systems, comprising:
a control unit, for generating control information according to the bands corresponding to signals to be received and signals to be transmitted;
a band switching unit, for switching to the propagation path of the corresponding band to transfer the corresponding signals, according to the control information;
an RF processing unit, for RF processing received signals transferred from the band switching unit, and RF processing signals to be transmitted in corresponding bands according to the control information so as to transmit the RF signals from the band switching unit;
a base-band processing unit, for converting RF signals from the RF processing unit into base-band signals, and transferring the base-band signals to be transmitted to the RF processing unit to be RF processed according to the control information.

5. The mobile terminal according to claim 4, wherein said RF processing unit comprises:
an Rx (receiving) signal processing module, for RF processing the received signals transferred from said band switching unit, so as to input them to said base-band processing unit;
a modulating module, for modulating signals to be transmitted from said base-band processing unit into RF signals, according to said control information;
a Tx band switching unit, for switching the modulated signals to the transmission path of the corresponding band, according to said control information;
a plurality of Tx RF processing units corresponding to different bands, for RF processing the modulated signals from the Tx band switching unit in corresponding bands, so as to transmit the RF signals from said band switching unit.

6. The mobile terminal according to claim 5, wherein said Rx signal processing module comprises:
a plurality of Rx RF processing units corresponding to different bands, for RF processing signals transferred from the propagation paths of said corresponding bands;
an Rx band switching unit, for receiving RF signals from the Rx RF processing unit in corresponding band, according to said control information;
a demodulating module, for demodulating RF signals from the Rx band switching unit and outputting the demodulated signals to said base-band processing unit, according to said control information.

7. The mobile terminal according to claim 1, wherein said control unit generates control information for corresponding modes based on signals to be received and signals to be transmitted, further comprising:
a mode switching unit, for switching the propagation path of said corresponding band to the propagation path of the corresponding mode, so as to transfer corresponding signals between said band switching unit and said RF processing unit, according to the control information.

8. The mobile terminal according to claim 7, wherein said mode switching unit comprises:
a mode switching unit in corresponding band, for switching the propagation path of said corresponding band to the propagation path of the corresponding mode, according to said control information;
a plurality of mode TRx (transceiving) processing units, for processing the corresponding signals from the propagation path of the corresponding mode in the corresponding modes, so as to transfer corresponding signals between said band switching unit and said RF processing unit, according to said control information.

9. The mobile terminal according to claim 8, wherein said plurality of mode TRx processing units at least contain TDD mode TRx switching unit and FDD mode duplex unit.

10. A mobile terminal in wireless communication systems, comprising:
a control unit, for generating control information according to the modes corresponding to signals to be received and signals to be transmitted;
a mode switching unit, for switching to the propagation path of the corresponding mode to transmit the corresponding signals, according to the control information;
an RF processing unit, for RF processing the received signals transferred from the propagation path of the corresponding mode, RF processing the RF signals to be transmitted and then transmitting the RF signals from the propagation path of the corresponding mode;
a base-band processing unit, for converting RF signals from said RF processing unit into base-band signals, and transferring the base-band signals to be transmitted to the RF processing unit to be RF processed.

11. The mobile terminal according to claim 10, wherein said control unit generates the control information for corresponding bands based on signals to be received and signals to be transmitted, further comprising:
a band switching unit, for switching to the propagation path of the corresponding band, so as to transfer said corresponding signals between the propagation path of the corresponding band and the propagation path of said corresponding mode, according to the control information;
said RF processing unit, for correspondingly RF processing signals transferred from the propagation path of the corresponding band, according to the control information.

12. The mobile terminal according to claim 11, wherein said RF processing unit comprises:
a Tx signal processing module, for RF processing signals from said base-band processing unit to be transmitted, so as to transmit the RF signals from said band switching unit;
a plurality of Rx RF processing units corresponding to different bands, for RF processing received signals transferred from the propagation path of said corresponding mode;
an Rx band switching unit, for receiving RF signals from the Rx RF processing unit in the corresponding band, according to said control information;
a demodulating module, for demodulating RF signals from the Rx band switching unit and outputting the demodulated signals to said base-band processing unit.

13. The mobile terminal according to claim 10, wherein said control unit generates control information for corresponding bands based on the signals to be received and signals to be transmitted, further comprising:
a band switching unit, for switching to the propagation path of the corresponding band, so as to transfer said corresponding signals between the propagation path of the corresponding band and the propagation path of said corresponding mode, according to the control information;
said RF processing unit, for RF processing signals to be transmitted in corresponding bands, so as to transmit the RF signals from the band switching unit, according to the control information.

14. The mobile terminal according to claim 13, wherein said RF processing unit comprises:
a Rx signal processing module, for RF processing received signals transferred from said band switching unit to output them to said base-band processing unit;
a modulating module, for modulating RF signals from said base-band processing unit to be transmitted into RF signals, according to said control information;
a plurality of TX RF processing unit corresponding to different bands, for RF processing the modulated signals from the Tx band switching unit in corresponding bands, so as to transmit the RF signals from said band switching unit.

15. The mobile terminal according to claim 2, wherein said demodulating module comprises:
a local oscillation generating unit, for generating local oscillation signals in corresponding bands, according to said control information;
a demodulating unit, for demodulating RF signals from the Rx band switching unit and outputting the demodulated signals to said base-band processing unit, by utilizing the local oscillation signals.

16. The mobile terminal according to claim 3, wherein said modulating module comprises:
a local oscillation generating unit, for generating local oscillation signals in corresponding bands, according to said control information;
a modulating unit, for modulating signals to be transmitted from said base-band processing unit into RF signals, by utilizing the local oscillation signals.

17. The mobile terminal according to claim 15, wherein said local oscillation generating unit comprises:
a frequency synthesizer, for generating frequency signals;
a frequency splitter, for splitting the frequency signals to get the local oscillation signals in corresponding bands, according to the control information of said control unit.

18. The mobile terminal according to claim 17, wherein said frequency synthesizer generates signals of frequency at around 4 GHz.

19. The mobile terminal according to claim 11, wherein said mode switching unit comprises:
a mode switching unit in corresponding band, for switching the propagation path of said corresponding band to the propagation path of the corresponding mode, according to said control information;
a plurality of mode TRx processing unit, for processing the corresponding signals from the propagation path of the corresponding mode in the corresponding modes, so as to transfer corresponding signals between said band switching unit and said RF processing unit, according to said control information.

20. The mobile terminal according to claim 19, wherein said mode TRx processing unit at least includes: TDD mode TRx switching unit and FDD mode duplex unit.

21. A communication method for mobile terminals in wireless communication systems, comprising:
determining the band corresponding to received signals, according to radio signals to be received;
RF processing received signals in corresponding band, according to determined band;
base-band processing the RF processed signals.

22. The method according to claim 21, further comprising:
determining the band corresponding to signals to be transmitted;
RF processing the base-band processed signals in corresponding band, according to determined band;
transmitting the RF signals corresponding to said band;

23. The method according to claim 21, further comprising:
determining the modes corresponding to signals to be received and signals to be transmitted;
transferring the received signals and signals to be transmitted, according to determined modes.
